(19) United States
(12) Patent Application Publication
(10) Pub. No.: US 2014/0200903 A1
(43) Pub. Date: Jul. 17, 2014

(54) Systems and Methods for Providing Emergency Alerts on a Geospatial Display

(71) Applicant: MCKESSON FINANCIAL HOLDINGS, Hamilton (BM)

(72) Inventors: Kenneth Hancock, Vestavia Hills, AL (US); Kevin Johnson, Hoover, AL (US); Bryan Self, Birminghan, AL (US); Mark Skiba, Birmingham, AL (US); John Stanton, Hoover, AL (US); Stephen Thompson, Birmingham, AL (US); Brandon Wedgeworth, Alabaster, AL (US)

(73) Assignee: MCKESSON FINANCIAL HOLDINGS, Hamilton (BM)

(21) Appl. No.: 13/739,884

(22) Filed: Jan. 11, 2013

(51) Int. Cl. G08B 21/00; G06Q 50/22

(52) U.S. Cl. CPC G08B 21/00; G06Q 50/22
USPC 705/2

(57) ABSTRACT

Embodiments include systems and methods for providing emergency alerts on a geospatial display. In one embodiment, a method is provided. The method can include receiving event data from one or more data management systems. The method can include determining at least one emergency event exists based at least in part on the received event data. Furthermore, the method can include outputting, via a display device, a scaled geospatial arrangement corresponding with a physical location, a grid, or a list. Moreover, the method can include outputting, via a display device, at least one color corresponding to the at least one emergency event, wherein the at least one color is one of a set of pre-assigned colors.

### FIELD OF THE DISCLOSURE

Aspects of the disclosure relate generally to health care, and more particularly, to systems and methods for providing emergency alerts on a geospatial display.

### BACKGROUND

Health care settings, such as hospitals and patient care facilities, can involve relatively complex information and work flows. Health care workers can serve in a wide variety of roles and work in many different physical locations across a hospital or other enterprise. Some workers, such as physicians, can be very mobile. As would be expected in such an environment, effective communication among workers can be essential for the overall operation of a hospital or other enterprise to be coherent and productive.

Conventional data management systems in such environments can be time consuming to read and use. In some instances, visual display boards can be provided by certain data management system vendors for use at a facility, such as a hospital or patient care facility. However, conventional visual display boards may only provide certain status information, which may still be time consuming to read and use.

### SUMMARY

Some or all of the above problems may be addressed by certain embodiments of the disclosure. Embodiments of the disclosure may include systems and methods for providing emergency alerts on a geospatial display. According to one embodiment, a system is provided. The system can include at least one memory for storing computer-executable instructions; and at least one processor configured to access the memory and further configured to execute the computer-executable instructions. The instructions can be operable to receive event data from one or more data management systems. The instructions can be further operable to determine at least one emergency event exists based at least in part on the received event data. Furthermore, the instructions can be operable to output, via a display device, a scaled geospatial arrangement corresponding with a physical location, a grid, or a list. Moreover, the instructions can be operable to output, via the display device, at least one color corresponding to the at least one emergency event, wherein the at least one color is one of a set of pre-assigned colors.

In another embodiment, a method is provided. The method can include receiving event data from one or more data management systems. The method can include determining at least one emergency event exists based at least in part on the received event data. Furthermore, the method can include outputting, via a display device, a scaled geospatial arrangement corresponding with a physical location, a grid, or a list. Moreover, the method can include outputting, via a display device, at least one color corresponding to the at least one emergency event, wherein the at least one color is one of a set of pre-assigned colors.

In yet another embodiment, one or more computer-readable media storing computer-executable instructions can be provided. When executed by at least one processor, the computer-executable instructions can configure the at least one processor to receive event data from one or more data management systems, wherein the data management systems comprise at least one of the following: a clinical system, an ADT system, an admission system, an environmental service system, an order and results system, a case management system, a transporter system, and a data system with event data associated with a patient care facility. The computer-executable instructions can further configure the at least one processor to determine at least one emergency event exists. Further, the computer-executable instructions can configure the at least one processor to output, via a display device, a scaled geospatial arrangement corresponding with a physical location, a grid, or a list. Moreover, the computer-executable instructions can configure the at least one processor to output, via a display device, at least one color corresponding to the at least one emergency event, wherein the at least one color is one of a set of pre-assigned colors. The computer-executable instructions can further configure the at least one processor to output, via the display device, text corresponding to the at least one emergency event. And, the computer-executable instructions can configure the at least one processor to overlay the at least one color and text on at least one of a scaled geospatial arrangement corresponding with a physical location, a grid, or a list.

Other systems, methods, apparatuses, features, and aspects according to various embodiments of the disclosure will become apparent with respect to the remainder of this document.

### BRIEF DESCRIPTION OF THE DRAWINGS

Reference will now be made to the accompanying drawings, which are not necessarily drawn to scale, and wherein:

FIG. 1 illustrates an example visual display for certain systems and methods according to example embodiments of the disclosure.

FIG. 2 illustrates another example visual display for certain systems and methods according to example embodiments of the disclosure.

FIG. 3 illustrates an example system, according to example embodiments of the disclosure.

FIG. 4 illustrates an example user interface for systems and methods, according to example embodiments of the disclosure.

FIG. 5 illustrates another example user interface for systems and methods, according to example embodiments of the disclosure.

FIG. 6 illustrates a flow diagram view of an example method, according to example embodiments of the disclosure.

### DETAILED DESCRIPTION

Embodiments of the disclosure will be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those of ordinary skill in the art. Like numbers refer to like elements throughout.

Embodiments of the disclosure can provide systems and methods for providing emergency alerts on a geospatial display. Certain embodiments of the disclosure can provide interaction with multiple data management systems to visualize information and alert personnel about certain emergency events in a facility, such as a patient care facility.

In one embodiment, event data can be aggregated from multiple data management systems or health care information systems. Data aggregation and/or integration can be managed by certain system embodiments using one or more healthcare industry standards, such as HL7, and can utilize one or more APIs (application program interfaces) for custom interfaces used to gather certain information from certain data management systems and health care information systems. Aggregating real-time event data from multiple systems can capture relevant activities within a particular environment, such as a health care environment or patient care facility, and some or all of the aggregated event data can be immediately visualized in a graphical interface with multiple tiers of indications.

In one embodiment, some or all of the event data can be presented as status updates on an output device in a unique visual display algorithm. For example, a visual display algorithm for communication of certain event data can include multiple tiers of indications including a background color and timer, one or more rotating status icons and timers, text based labels, and an organized visual palette for these components, such as a geospatial arrangement or map, a spreadsheet style grid, or a cross-sectional list of patients and rooms. Certain embodiments of a visual display network can provide certain transport mechanics to deliver the visual display algorithm to one or more users. In one example, a visual display network can include a set of network connected display devices, handheld computers, and desktop computers that can receive and output the visual display algorithm.

In one embodiment, systems and methods for emergency alerts can permit any number of emergency events, colors, text, and associated process rules to be configured through a workflow application program. The process rules can be a unique implementation of a set of business rules which can affect the timing, order, and overlay of the events, colors, and text.

In this manner, certain system and method embodiments can provide a visual information package to help a hospital or patient care facility manage patient care needs. One technical effect achieved by certain embodiments of the disclosure can include increased personnel or worker communications as well as situational awareness, resulting in improved efficiency and effectiveness.

These and other embodiments are described more fully below with reference to the accompanying figures, in which embodiments of the disclosure are shown.

The term “event data” as used within this specification is defined as an activity during any instance or duration of time. Examples of event data can include, but are not limited to, a manual indication or user input indication of a particular event or occurrence; a patient care activity or event; an activity that occurs in a health care environment; an activity capable of being tracked by a health care information system, such as an admission, transfer or discharge of a patient, or the creation of an order or result associated with a patient; completion of an activity or series of activities; an indication by a user via a client device that particular information should be removed, modified or updated; expiration of an item over a period of time; expiration of a preset time; the presence or absence of a patient or staff member in a certain physical area; a patient's falling; a change in the patient location; and an event notification from a patient monitoring device, such as a heart rate monitor.

The terms “indication” and “indicator”, and their pluralized terms, used within this specification can include, but are not limited to, an icon, a rotating icon, a color, a background color, a safety indicator, a limit, a range, a warning, a statistic, a health status, a date, a time, a timer, a rotating timer, text, contact information, a health-related statistic, a body function, patient care information, a patient care state, a special patient care state, and a patient care activity.

The term “geospatial arrangement” and “geospatial display” are used interchangeably, and as used within this specification are defined as the organization of data or information relative to a map or map-type view of a particular area.

The term “emergency event” as used within this specification is defined as any event that may need heightened personnel attention or awareness. Examples of an emergency event can include, but are not limited to, missing infant or child, bomb threat, suspicious object, missing adult, severe weather, hazardous material release, decontamination incident, fire, smoke, suspicious smell or odor, armed person or person with a weapon, hostage situation, violent situation, external disaster, internal disaster, utility failure, a non-medical emergency type circumstance or event, adult medical emergency, pediatric medical emergency, or neo-natal medical emergency.

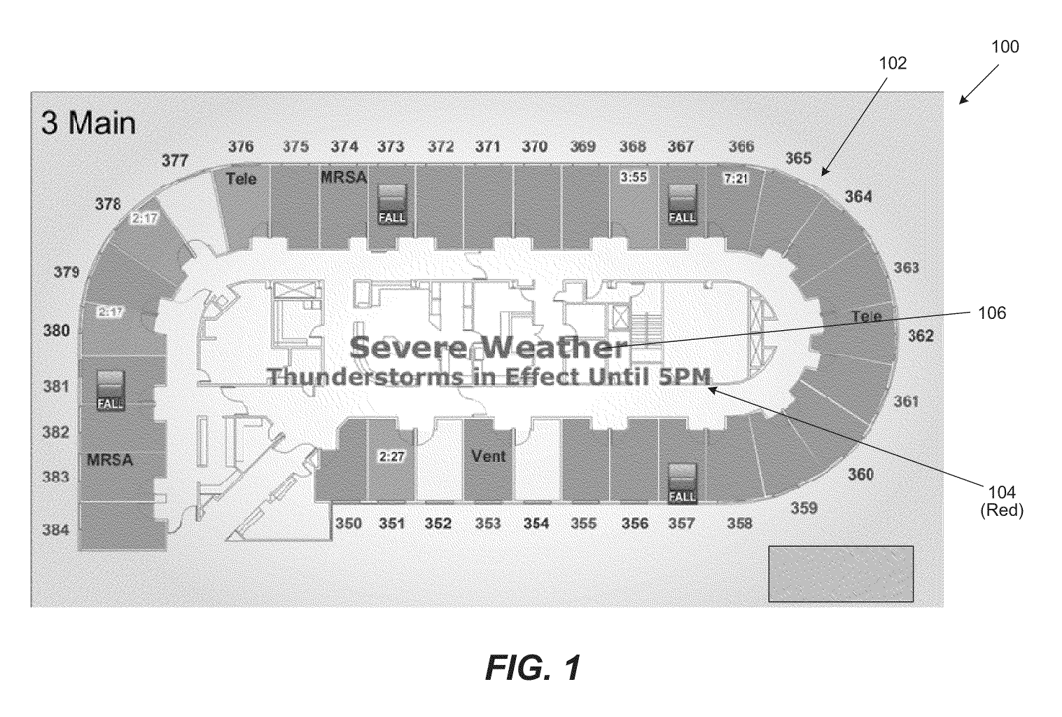

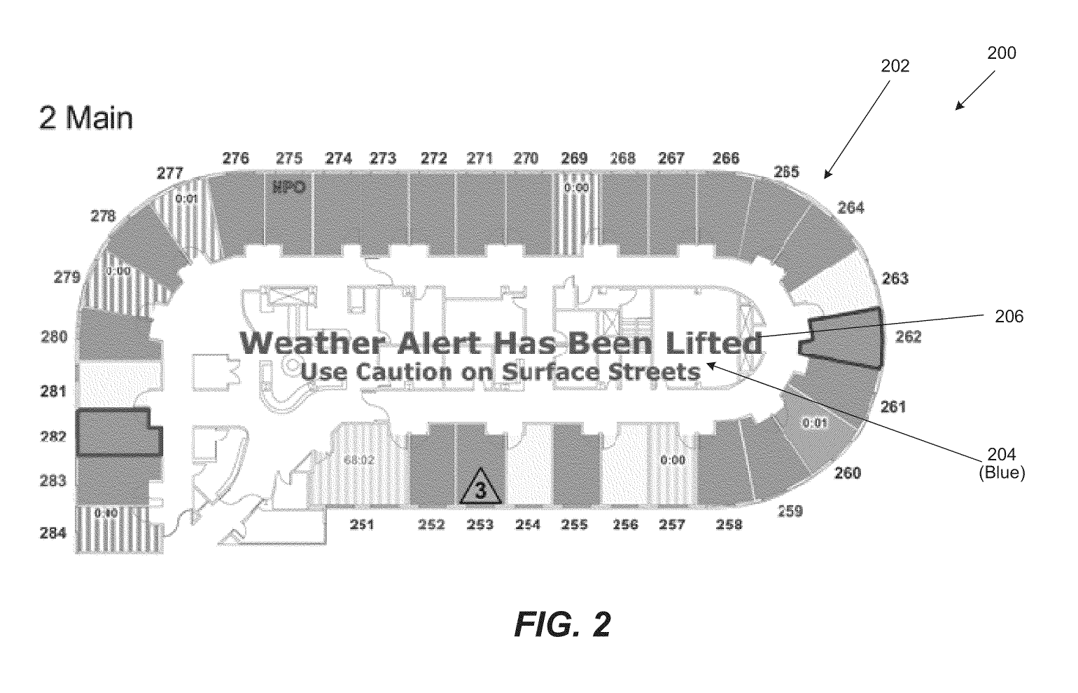

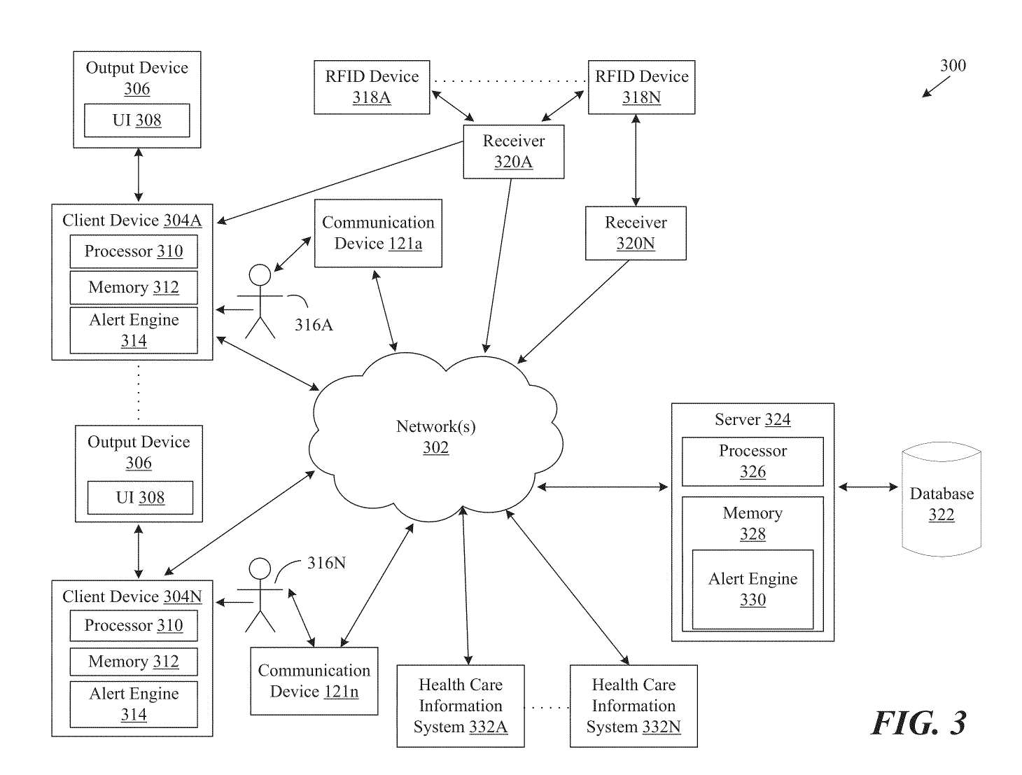

FIGS. 1 and 2 illustrate example visual displays or user interfaces for certain systems and methods according to example embodiments. In these examples, an output device, such as a display monitor, can facilitate display of a graphical user interface, such as 100, 200. An alert engine or application program, further described in FIG. 3, can generate the graphical user interface 100 with a scaled geospatial arrangement 102, 202 of various information, such as graphical information, associated with a patient, including location information associated with a patient and one or more indications and/or indicators of care of a patient. For example, the graphical user interface can include a scaled map or geospatial view of a health care environment, such as a hospital or patient care facility.

Event data from one or more data management systems can be received by the alert engine or application program, and at least one emergency event can be determined from the event data. When the existence of an emergency event is determined, the alert engine or application program can generate at least one color associated with the emergency event.

In the example of FIG. 1, the color “red” may be generated by the alert engine or application program, and overlaid on a portion of the scaled geospatial arrangement 102. Textual information 104, such as “Severe Weather Thunderstorms in Effect Until 5 PM” may also be generated by the alert engine or application program, and overlaid on a portion of the scaled geospatial arrangement 102. In certain embodiments, the textual information 104 can be output in the selected color 102, but in other embodiments, the textual information 104 and color 102 may be separate.

In the embodiment shown in FIG. 1, the selected color 102 can be one or a set of pre-assigned colors, such as previously assigned conventional color code system that may already be used in an environment. For example, the color red can be assigned to a relatively high priority alert, and the color yellow can be assigned to a relatively lower priority alert. In another example, a palette of colors can each be assigned to a certain alert. In one embodiment, examples of colors and corresponding alerts can be as follows:

Black=bomb threat/suspicious object

Brown=missing adult

Gray=severe weather

Orange=hazardous release/decontamination incident

Red=Fire/smoke/suspicious smell

Silver=person with a weapon/hostage situation

Violet=violent situation

Yellow=external disaster/internal disaster/utility failure

Blue=Adult medical emergency

Pink=pediatric/neonatal medical emergency

One skilled in the art may recognize a variety of colors and/or color standards may be implemented with certain embodiments of the disclosure, and the above examples are merely for illustration.

As shown in FIG. 2, the original alert shown in the color red with textual information can be modified as needed, such as when the alert status changes. In the example of FIG. 2, the color “blue” may be generated by the alert engine or application program, and overlaid on a portion of the scaled geospatial arrangement 202. Textual information 204, such as “Weather Alert Has Been Lifted_Use Caution on Surface Streets” may also be generated by the alert engine or application program, and overlaid on a portion of the scaled geospatial arrangement 202.

In any instance, the ability of the alert engine or application program to determine emergency events and to output certain colors and/or text to a graphical user interface with a scaled geospatial arrangement, such as interface 100 with arrangement 102, can increase the situational awareness of certain personnel working in an environment, such as a healthcare facility.

In certain embodiments, the data management systems can include at least one of the following: a clinical system, an ADT system, an admission system, an environmental service system, an order and results system, a case management system, a transporter system, and a data system with event data associated with a patient care facility.

In certain embodiments, a scaled map or geospatial view can be divided, for example, into multiple areas that represent the relative location of rooms in a hospital. One or more areas within or adjacent to the scaled map or geospatial view can display graphical information associated with a status of a particular patient, such as location information associated with a patient or an indicator of care of a patient. In other embodiments, different combinations of graphical information and indications, and orientations of a scaled geospatial arrangement can be displayed on a graphical user interface.

In certain embodiments, sounds, tactile feedback, and other physical phenomena can be generated by an alert engine or application program in addition to the colors and/or text generated for an emergency alert. Such sounds, tactile feedback, and other physical phenomena could be generated adjacent to or near the output device that is in communication with the alert engine or application program.

In certain embodiments, an exit route from the environment can be indicated by the alert engine or application program in addition to the colors and/or text generated for an emergency alert. The exit route from the environment could be generated on the output device that is in communication with the alert engine or application program.

FIG. 3 is an example system in accordance with various embodiments of the disclosure. The system 300 shown is by way of example, and the system can operate in a variety of environments, such as a health care environment, a patient care facility, or a hospital. The system 300 of FIG. 3 is shown with one or more communications networks 302 in communication with one or more client devices 304A-304N, which in turn are in communication with one or more output devices 306. The output devices 306 can display or otherwise output via a respective user interface (UI) 308, a scaled geospatial arrangement such as 100, 200 as illustrated in FIGS. 1 and 2. The scaled geospatial arrangement can include any number of colors and/or text generated in response to an emergency event. Any number of client devices 304A-304N can also be in communication with the one or more networks 302. The one or more communications networks 302 shown in FIG. 3 can include a wireless communications network, wired communications network, the Internet, or any combination thereof. Other types of communications networks can be used in accordance with various embodiments of the disclosure.

Each client device 304A-304N can be a computer or processor-based device capable of communicating with the one or more communications networks 302 via a signal, such as a wireless frequency signal or a direct wired communication signal. Each client device, such as 304A-N, can include at least one processor 310 and a computer-readable medium, such as a random access memory (RAM) 312 or other non-transitory medium, coupled to the processor(s) 310. The processor(s) 310 can execute computer-executable program instructions stored in memory 312 or otherwise accessible by the processor 310. The computer-executable program instructions can include any number of engine modules or application programs, such as an alert engine 314. Each alert engine 314 can be configured to receive one or more user inputs correlating at least one color to a respective emergency event. Further, each alert engine 314 can be configured to determine at least one emergency event exists. Each alert engine 314 can be configured to output, via a display device or output device 306, a scaled geospatial arrangement corresponding with a physical location, a grid, or a list. Moreover, each alert engine 314 can be configured to output, via a display device or output device 306, at least one color corresponding to the at least one emergency event, wherein the at least one color is one of a set of pre-assigned colors. Further, each alert engine 314 can be configured to output, via the display device, text corresponding to the at least one emergency event. And, each alert engine 314 can be configured to overlay the at least one color and text on at least one of a scaled geospatial arrangement corresponding with a physical location, a grid, or a list.

The processor(s) of FIG. 3 may comprise a microprocessor, an ASIC, and state machines. The processor(s) comprise, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor(s) 310, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Client devices 304A-304N may also comprise a number of external or internal devices such as a mouse, a CD-ROM, DVD, a keyboard, a touch display, or other input or output devices. Examples of client devices 304A-304N are personal computers, mobile computers, handheld portable computers, digital assistants, personal digital assistants, cellular phones, mobile phones, smart phones, pagers, digital tablets, pad devices, desktop computers, laptop computers, Internet appliances, and other processor-based devices. In general, a client device, such as 304A, may be any type of processor-based platform that is connected to a network, such as 302, and that interacts with one or more application programs. Client devices 304A-304N may operate on any operating system capable of supporting a browser or browser-enabled application, such as Microsoft® Windows® or Linux. The client devices 304A-304N shown include, for example, personal computers executing a browser application program such as Microsoft Corporation's Internet Explorer™, Netscape Communication Corporation's Netscape Navigator™, and Apple Computer, Inc.'s Safari™

A user, such as 316A, can interact with a client device, such as 304A, via an input device such as a keyboard, a mouse, or a gesture and/or voice command or control device. For example, a user can input information, such as event information, emergency event information, or a color associated with an emergency event, by keying text via a keyboard or inputting a command via a mouse, using a stylus or using a bare finger, inputting a gesture via a gesture command or control device, or inputting a voice input via a voice command or control device. In one embodiment, a user 316A can input one or more commands via a client device 304A to select one or more desired colors for display via an output device, such as 306, and configure a graphical user interface, such as 308, to output the one or more colors on a geospatial arrangement when certain emergency events are detected or otherwise determined.

One suitable output device can be a display device capable of displaying information in a geospatial arrangement on a graphical user interface. Another suitable output device is a McKesson™ patient care communication display board capable of displaying location information associated with a patient, an indicator of care of a patient, or other patient process care information in a map, geospatial-type view, table, or grid-type view. Other types of output devices can include, but are not limited to, private-type displays, public-type displays, plasma displays, LCD displays, touch screen devices, and projector displays on cinema-type screens. In some embodiments, the Scalable Vector Graphics (“SVG”) standard for describing graphical information, or a similar suitable standard or technique, may be utilized as part of the graphical rendering process. Examples of a suitable graphical user interface for an output device, such as 306, are shown and described below in FIGS. 1 and 2.

In one embodiment, multiple output devices such as public-type displays or flat screen monitors can be mounted in a health care environment, such as in rooms, hallways, on doors, in central monitoring areas, or other areas where users or health care personnel may work, be stationed, or otherwise desire information associated with a patient's location or patient's health care status. In other embodiments, an output device such as private-type display or a computer display monitor can be connected to or associated with a client device, such as a handheld portable computer device or a desktop personal computer (PC).

In the embodiment shown in FIG. 3, a device, such as 318A, capable of providing location information associated with a patient can be in communication with a client device, such as 304A. A corresponding receiver, such as 320A, capable of receiving location information associated with a patient can interface or otherwise facilitate communication between the device 318A and the client device 304A. Multiple devices, such as 318A-318N, capable of providing location information associated with respective patients can also be in communication with a client device, such as 304A, via the same receiver, such as 320A, or any number of other receivers. Other receivers, such as 320N, capable of receiving location information associated with a patient can interface or otherwise facilitate communication between any number of devices capable of providing location information associated with respective patients and a client device. A suitable device capable of providing location information associated with a patient can be a radio frequency identification device (RFID) or near field communications (NFC) device, and a suitable receiver capable of receiving location information associated with a patient can be a RFID or NFC reader. Other types of devices and technologies capable of providing location information associated with a patient can be used with other embodiments of the disclosure, including, but not limited to, passive-type RFID, active-type RFID, NFC, wireless, infrared, global positioning satellite (GPS)-type devices or other devices capable of providing location information associated with a patient or otherwise facilitating determination of a location associated with a patient, staff member, or piece of medical equipment.

In at least one embodiment, a device capable of providing location information associated with a patient, and a corresponding receiver capable of receiving location information associated with a patient can communicate with a client device via a network. For example as shown in FIG. 1, device 318N and receiver 320N can communicate with client device 304A via the one or more networks 302. In another embodiment, a device capable of providing location information associated with a patient can communicate with both the one or more networks 302 and one or more client devices 304A-304N, either with or without a corresponding receiver capable of receiving location information associated with a patient. In some instances, a receiver capable of receiving location information associated with a patient can be incorporated into or otherwise associated with a client or another device associated with one or more networks. In any of these instances, a device capable of providing location information associated with a patient and a corresponding receiver capable of receiving location information associated with a patient can communicate the location information to a remote location via one or more networks, such as 302.

In one embodiment, any type of wireless location tracking technology, such as active RFID or NFC, can be used to provide real time location information about one or more patients' locations in a health care environment. Such locations can be tracked automatically by an alert engine, such as 314 in FIG. 3 and described below, via the wireless location tracking technology as each patient moves throughout a health care environment, such as a hospital, floor, or room.

In one embodiment, each client device, such as 304A-304N, can be associated with a unique identifier. Examples of suitable identifiers are serial numbers, Ethernet MAC addresses, IP addresses, numbers generated via random and/or pseudo-random algorithms etc. A database, such as 322 in FIG. 3 and described below, or other data storage device can store the unique identifiers for subsequent retrieval. In this manner, the system 300 can record the location of a client device, such as 304A or a desktop computer, so that the display configuration for an associated output device, such as 306, can be changed based on the location of the client device or desktop computer. For example, a client device or desktop computer on a third floor of a building in a health care environment may only be able to display information about patients on that particular floor. By associating a unique identifier with each client device or desktop computer, the system 300 can track the location of each client device or desktop computer, and in particular mobile client devices, to support dynamic information display on the associated output device based on the current location of the particular client device.

The system 300 can also include a server 324 in communication with the one or more networks 302. Similar to the client devices 304A-304N, the server device 324 shown can include a processor 326 coupled to a computer-readable memory 328. The processor 326 can access computer-executable instructions stored in memory 328 or otherwise accessible by the processor 326, such as an alert engine 330 or application program, which can include similar functionality as the alert engines 314 associated with the client devices 304A-304N. The alert engine 330 and server device 324 can cooperate, or otherwise operate individually, to aggregate event data from one or more data management systems or health care information systems, such as 332A-332N, to receive information, such as event data or real time events associated with one or more patient care processes as well as indicators of care of one or more patients.

The server device 324 can be in communication with a database, such as 322, or other data storage device. The database 322 can receive and store data from the server 324, or from a client device, such as 304A, via the one or more networks 302. Data stored in the database 322 can be retrieved by the server 324 or client devices 304A-304N as needed.

Server device 324, depicted as a single computer system, may be implemented as a network of computer processors. Examples of a server device 324 are servers, mainframe computers, networked computers, a processor-based device, and similar types of systems and devices. Client processors 310 and the server processor 326 can be any of a number of computer processors, such as processors from Intel Corporation of Santa Clara, Calif. and Motorola Corporation of Schaumburg, Ill. The computational tasks associated with rendering the graphical image could be performed on the server device(s) and/or some or all of the client device(s).

In certain embodiments, the alert engine 330 and server device 324 can integrate with and can communicate with other information systems in a health care environment to receive such information. In any instance, the received event data, real time events, and indications can be stored in a database 322 or other data storage device to support real time and dynamic updating of information displayed on some or all of the output devices 306. As shown in FIG. 3, an information system such as one or more data management systems or health care information systems, such as 332A-332N, can communicate with the server 324 and alert engine 330 via the one or more networks 302. In one embodiment, communications by the server 324 and alert engine 330 with other suitable data management systems or health care information systems, such as 332A-332N, can be based on an industry standard HL7 communication model. In another embodiment, communications by the server 324 and alert engine 330 with other suitable data management systems or health care information systems, such as 332A-332N, can be through one or more APIs. In yet another embodiment, a custom integration of the server 324 with other suitable data management systems or health care information systems, such as 332A-332N, can achieve similar results to an industry standard HL7 communication model. Examples of suitable data management systems or health care information systems the server device 324, the alert engine 330, and other components of the system 300 can aggregate event data from, integrate with, or otherwise communicate with can include, but are not limited to, an ADT (admission, discharge, and transfer) system, an ordering system, an ED/OR-type (emergency/operating room) system, an EVS-type (enterprise vocabulary system) system, an IVR (interactive voice response) system, a staffing system, an InterQual-type system, an ED tracking system, a location system, a result reporting system, a lab-type system, a pharmacy-type system, a radiology-type system, a transcription-type system, an environmental services-type system, and a transportation-type system.

Information associated with various indicators of care associated with one or more patients can be received by the server 324 and alert engine 330 via the one or more networks 102 from one or more client devices 304A-304N, the database 322 or other data storage devices, and from one or more data management systems or health care information systems 332A-332N. In one embodiment, information associated with an indicator of care of a patient can be input by a user 316A, such as an attending physician, via a client device 304A, such as a handheld portable computer or desktop computer. The information can be received as one type of event data by the server 324 via the one or more networks 302 for processing by the alert engine 330 or storage by the database 322 or other data storage device. In another embodiment, information associated with an indicator of care associated with one or more patients can be received or otherwise obtained as another type of event data from a data management system or health care information system, such as 332A-332N, database 322, or other data storage device or information source. Further, other event data associated with a patient care or health care environment can be received or otherwise obtained as another type of event data from a data management system or health care information system, such as 332A-332N, database 322, or other data storage device or information source. In any instance, the alert engine 330 can ultimately receive or obtain, and aggregate some or all of such information as event data from such sources via the server 324 and the one or more networks 302.

In one embodiment, an alert engine 314, 330 can receive one or more user inputs correlating to at least one emergency event to at least one color. The alert engine 314, 330 can facilitate outputting a graphical user interface via a display device, such as interface 308 on output device 306, to receive selected user options and input information about an emergency event, one or more associated colors, such as text and/or background color, and one more messages or text associated with the emergency event.

In one embodiment, an alert engine 314, 330 can receive event data from one or more data management systems. For example, the alert engine 314, 330 can receive event data from one or more healthcare information systems 332A-332N, which permit the alert engine 314, 330 to monitor for any number of emergency events. In some embodiments, the alert engine 314, 330, or another engine or application program, can receive and process the event data, such as a location associated with a patient and an indicator of care of the patient. The alert engine 314, 330, or another engine or application program, may facilitate output of a geospatial arrangement and graphical display of information associated with a particular patient on an output device, such as interface 308 on output device 306, including location information associated with the patient and an indicator of care of the patient. In certain embodiments, an alert engine 314, 330 can output via a display device, a scaled geospatial arrangement corresponding to a physical location, a grid, or a list.

Using some or all of the received event data, certain embodiments of the alert engine 314, 330 can determine at least one emergency event exists. For example, the alert engine 314, 330 may include a list of predefined emergency events, which the alert engine 314, 330 monitors the event data for the occurrence of at least one of the emergency events. In another example, the alert engine 314, 330 may include a list of predefined conditions associated with one or more emergency events, which the alert engine 314, 330 monitors the event data for the occurrence of one or more conditions indicative of at least one of the emergency events. In yet another example, the alert engine 314, 330 may monitor for a manual indication or user indication that an emergency event has occurred. In any instance, the alert engine 314, 330 can determine when an emergency event occurs based at least in part on the received event data.

In one embodiment, an alert engine 314, 330 can output, via a display device, at least one color corresponding to a detected emergency event. For example, upon detection or receipt of an emergency event, the alert engine 314, 330 can generate a color via an output device, such as 308, corresponding to the detected or received emergency event. In some embodiments, the text can be a predefined color based on a user input. In other embodiments, a color may be selected by the alert engine 314, 330 based on the relative priority or importance of the detected or received emergency event.

In one embodiment, an alert engine 314, 330 can output, via a display device, text corresponding to a detected emergency event. For example, upon detection or receipt of an emergency event, the alert engine 314, 330 can generate text via an output device, such as 308, corresponding to the detected or received emergency event. In some embodiments, the color can be a predefined message or text based on a user input. In other embodiments, text may be selected by the alert engine 314, 330 based on the relative priority or importance of the detected or received emergency event, or may be based on key words or descriptions associated with the emergency event.

In one embodiment, an alert engine 314, 330 can overlay at least one color and text associated with the detected or received emergency event on a user interface or scaled geospatial arrangement. For example, upon detection or receipt of an emergency event, the alert engine 314, 330 can overlay at least one color and text on a user interface or scaled geospatial arrangement for display via the output device, such as 306.

In certain embodiments, sounds, tactile feedback, and other physical phenomena can be generated by an alert engine 314, 330, or application program, in addition to the colors and/or text generated for an emergency alert. Such sounds, tactile feedback, and other physical phenomena could be generated adjacent to or near the output device that is in communication with the alert engine 314, 330, or application program.

In certain embodiments, an exit route from the environment can be indicated by the alert engine 314, 330, or application program in addition to the colors and/or text generated for an emergency alert. The exit route from the environment could be generated on the output device that is in communication with the alert engine 314, 330, or application program.

In the above manner, an alert engine, such as 314, 330, can facilitate improved visual information to help an environment, such as a hospital or patient care facility, manage customer and/or patient care needs. Further, the alert engine 314, 330 can increase personnel or worker communications as well as situational awareness, resulting in improved efficiency and effectiveness.

The system 300 shown in, and described with respect to, FIG. 3 is provided by way of example only. Numerous other systems, operating environments and components, system architectures, and device configurations are possible. Accordingly, embodiments of the disclosure should not be construed as being limited to any particular system, operating environment or component, system architecture, or device configuration.

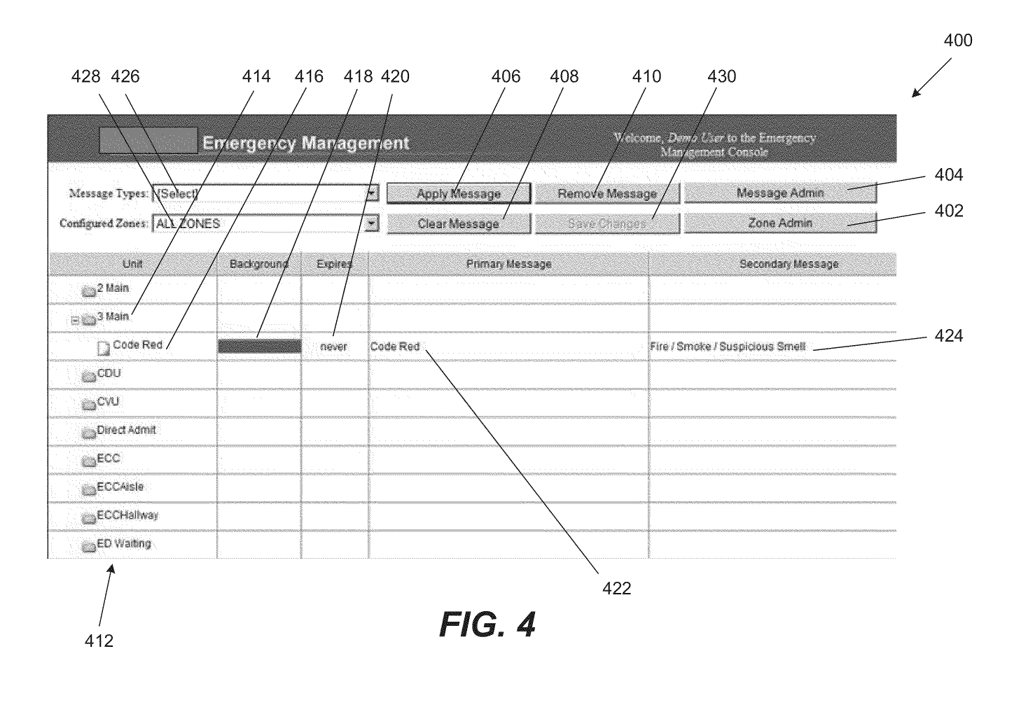

FIG. 4 illustrates an example user interface for a system and method according to an example embodiment of the disclosure. In this example, a graphical user interface 400 can facilitate user selection and management of one or more colors and associated emergency events for the creation, modification, and administration of emergency alerts on a geospatial display. An alert engine, such as 314, 330 in FIG. 3, can include one or more computer-executable instructions operable to generate the graphical user interface 400 with one or more selectable user options 402-410 to create and/or select for modification one or more emergency alerts within any number of zones in an environment, such as a healthcare environment, hospital, or patient care facility. For example, user option 402 or a “Zone Admin” button, can provide a window or user interface displaying some or all of the predefined zones in the environment. In one healthcare environment or hospital, predefined zones can include particular floors, wards, departments, units, rooms, aisles, hallways, or other areas. These zones can be identified by codes or keywords, for instance, MAIN WING. One or more predefined areas 412 within the environment can be selected for inclusion within a zone. Example areas can be identified by codes or keywords, for instance, 2 Main, 3 Main, Ward1, CVU, ICU, OR, SDS, Emergency Department, Overflow Beds, ECC, ECCAisle, ECCHallway, EIA, FLEX, CDU, Trauma, Policehold, Isolation, PACU, ED Waiting, Direct Admit, Interhospital Transfer, and Surgery. Typically, each predefined area can be associated with a scaled geospatial arrangement that can be output to a geospatial display or output device, such as user interface 308 on output device 306 in FIG. 3. In any instance, upon review of the predefined zones, a user can create a new zone, update a particular zone by selecting the desired zone and areas for inclusion within the zone, or delete a zone. The alert engine 314, 330 can store the user modifications in a database, such as 322 in FIG. 3, for subsequent retrieval.

Using the interface 400 shown in FIG. 4, a user can also view for a particular area, such as 414, any number of emergency alerts 416 and associated colors 416, alert expiration characteristics 418, primary alert messages or text 420, and secondary alert messages or text 422. Thus, for example, an area 414 such as 3MAIN, a predefined emergency alert 416 named CODE RED can include a red color 418, an expiration characteristic 420 of “NEVER,” a primary message 422 of “Code Red,” and a secondary message 424 of “Fire/Smoke/Suspicious Smell.”

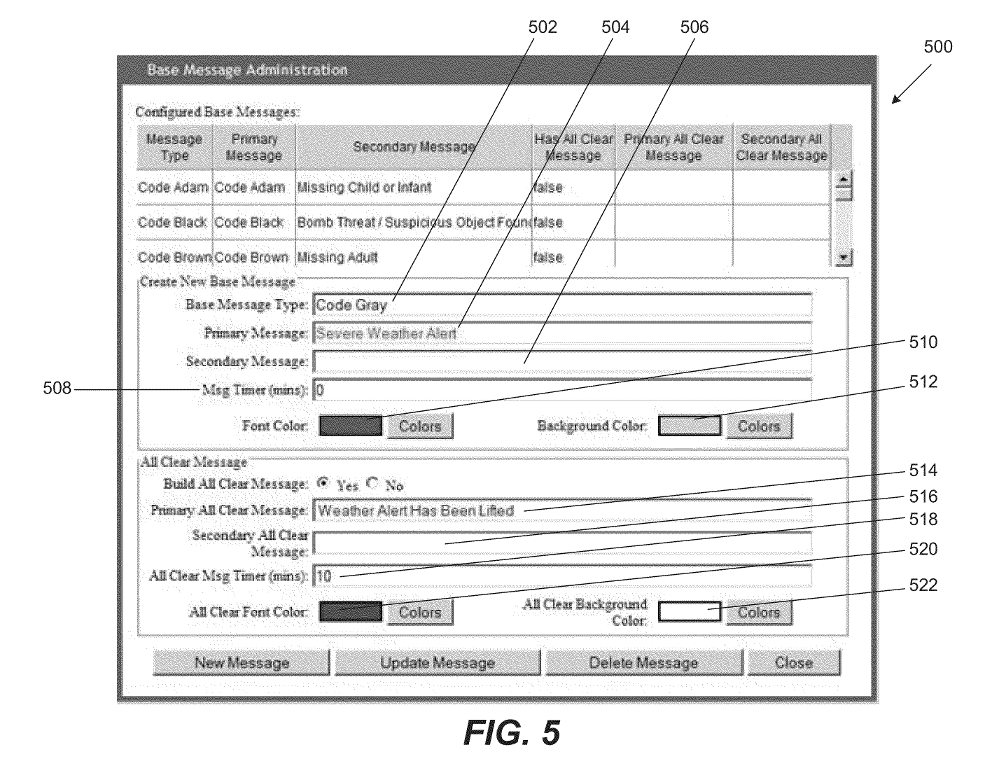

Another example selectable user option 404 or “Message Admin” button, for the user interface 400 shown in FIG. 4 can provide a window or user interface displaying some or all of the predefined emergency alert messages for the environment. An example user interface for the user option 404 is shown as 500 in FIG. 5. As shown in FIG. 5, the user interface 500 can facilitate user creation, modification, and management of predefined emergency alert messages with associated colors, primary messages or text, secondary messages or text, and timers. In the user interface 500 shown, the user can input a base message with a name 502 for an emergency alert, a primary message or text 504, a secondary message or text 506, a message timer 508, a font color 510 for the messages or text, and a background color 512 for the messages or text. Thus, in this example, a name 502 such as CODE GRAY can be input with a primary message or text 504 of “SEVERE WEATHER ALERT,” no secondary message or text 506, a message timer 508 of 0 minutes, a red font color 510, and a gray background color 512. Furthermore, the user interface 500 can facilitate user input of an optional all clear message with a primary all clear message or text 514, a secondary all clear message or text 516, a message timer 518, a font color for the messages or text 520, and a background color for the messages or text 522. Thus, in this example, a CODE GRAY alert can be input with a primary all clear message or text 514 of “WEATHER ALERT HAS BEEN LIFTED,” no secondary all clear message or text 516, a message timer 518 of 10 minutes, a blue font color 520, and a white background color 522. In any instance, when the user has finished reviewing, entering, or modifying a particular emergency alert message, the user can update the alert message, enter a new alert message, or delete the alert message. The alert engine 314, 330 can store the user modifications in a database, such as 322 in FIG. 3, for subsequent retrieval.

Turning back to FIG. 4, when a user desires to apply or otherwise associate an emergency message to a particular emergency alert, the user can select option 406, or the “Apply Message” button. This option 406 can facilitate the association of a selected message type from menu 426, such as CODE GRAY, and a configured zone from menu 428, such as ALL ZONES. The association of at least one message type with at least one configured zone permits the user interface to offer the user an option 430, or “Save Changes” button, which can instruct the alert engine 314, 330 to store the user modifications in a database, such as 322 in FIG. 3, for subsequent retrieval.

Likewise, if a user desires to clear or remove an emergency message from a particular emergency alert, the user can select option 408, the “Clear Message” button, or option 410, the “Remove Message” button. Option 408 can facilitate the clearing of a selected message type from menu 426, such as CODE GRAY, from a configured zone from menu 428, such as ALL ZONES. Similarly, option 410 can facilitate the removal of a selected message type from menu 426, such as CODE GRAY, from a configured zone from menu 428, such as ALL ZONES. In either instance, user selection of option 430, or the “Save Changes” button, can instruct the alert engine 314, 330 to store the user modifications in a database, such as 322 in FIG. 3, for subsequent retrieval.

In certain embodiments, a user may also designate or otherwise select one or more sounds, tactile feedback, and/or other physical phenomena that can be generated by an alert engine 314, 330, or application program, in addition to the colors and/or text generated for an emergency alert. Such sounds, tactile feedback, and other physical phenomena could be generated adjacent to or near the output device that is in communication with the alert engine 314, 330, or application program.

In certain embodiments, a user may designate or otherwise select an exit route from the environment to be indicated by the alert engine 314, 330, or application program in addition to the colors and/or text generated for an emergency alert. The exit route from the environment could be generated on the output device that is in communication with the alert engine 314, 330, or application program.

Thus, using the interfaces 400, 500 can permit creation of one or more emergency alerts with associated colors and text for output to a geospatial display or user interface on output display device, such as user interface 308 and output device 306 in FIG. 3. For example, as shown in FIGS. 1 and 2, the graphical user interfaces 100, 200 can include a scaled map or geospatial view of a health care environment, such as a hospital or patient care facility. An alert engine, such as 314, 330 can generate the scaled map or geospatial view, and overlay the map or view with an emergency alert including any number of colors and/or text corresponding to the emergency alert. In other embodiments, different combinations of colors and text, and orientations of a scaled geospatial arrangement with respect to the colors and/or text can be displayed on a graphical user interface.

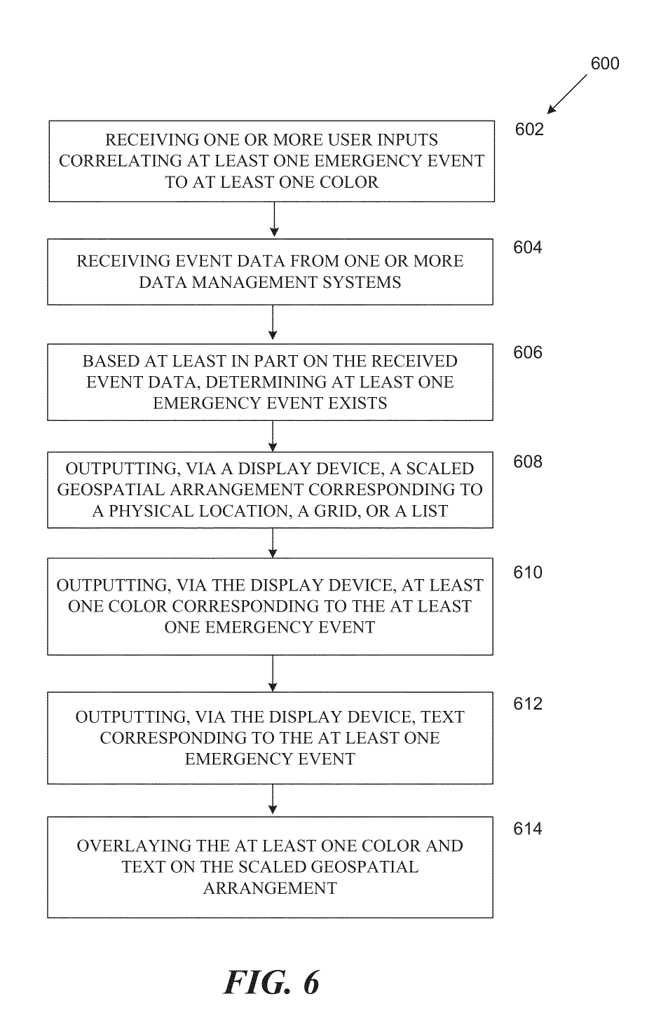

FIG. 6 represents a flow diagram for an example method for providing emergency alerts for a geospatial display according to embodiments of the disclosure. Certain operations of the method 600 can be implemented with certain embodiments of the disclosure, such as the system 300 in FIG. 3, and the visual displays or user interfaces in FIGS. 1-2 and 4-5. One will recognize that other method embodiments can include similar or different operations, elements and/or sequences, and in some instances, fewer or greater number of operations or elements.

The method 600 in FIG. 6 begins at block 602 in which one or more user inputs correlating to at least one emergency event to at least one color is received.

Block 602 is followed by block 604, in which event data is received from one or more data management systems.

In one aspect of an embodiment, event data can include at least one of the following: a real time event, data associated with a patient, and data associated with a patient care facility.

In one aspect of an embodiment, event data can be received from one or more data management systems, wherein the data management systems comprise at least one of the following: a clinical system, an ADT system, an admission system, an environmental service system, an order and results system, a case management system, a transporter system, and a data system with event data associated with a patient care facility.

Block 604 is followed by block 606, in which at least one emergency event is determined to exist based at least in part on the received event data.

In one aspect of an embodiment, an emergency event can include at least one of the following: missing infant or child, bomb threat, suspicious object, missing adult, severe weather, hazardous material release, decontamination incident, fire, smoke, suspicious smell or odor, armed person or person with a weapon, hostage situation, violent situation, external disaster, internal disaster, utility failure, adult medical emergency, pediatric medical emergency, and neo-natal medical emergency.

Block 606 is followed by block 608, in which a scaled geospatial arrangement is output, via the display device, corresponding to a physical location, a grid, or a list.

Block 608 is followed by block 610, in which at least one color is output, via the display device, corresponding to the at least one emergency event.

Block 610 is followed by block 612, in which text is output, via the display device, corresponding to the at least one emergency event.

Block 612 is followed by block 614, in which the at least one color and text are overlaid on the scaled geospatial arrangement.

In one aspect of an embodiment, one or more sounds, tactile feedback, and/or other physical phenomena that can be generated by an alert engine, or application program, in addition to the colors and/or text generated for an emergency alert. Such sounds, tactile feedback, and other physical phenomena could be generated adjacent to or near the output device that is in communication with the alert engine, or application program.

In one aspect of an embodiment, an exit route from the environment can be indicated by the alert engine, or application program in addition to the colors and/or text generated for an emergency alert. The exit route from the environment could be generated on the output device that is in communication with the alert engine, or application program.

The method 600 may end after block 614.

Accordingly, the example method illustrated in FIG. 6 can facilitate providing emergency alerts on a geospatial display.

Embodiments of the disclosure are described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

It will also be appreciated that each of the I/O interfaces described herein may facilitate communication between a processor and various I/O devices, such as a keyboard, mouse, printer, microphone, speaker, monitor, bar code readers/scanners, RFID readers, NFC readers, voice and/or gesture detectors or readers, and the like. Likewise, each of the network interfaces described herein may take any of a number of forms, such as a network interface card, a modem, a wireless network card, and the like.

It will further be appreciated that while certain computers have been illustrated herein as a single computer or processor, the illustrated computers may actually be comprised of a group of computers or processors, according to an example embodiment of the disclosure.

Many modifications and other embodiments of the disclosure will come to mind to one skilled in the art to which this disclosure pertains and having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system, comprising:
at least one memory for storing computer-executable instructions; and
at least one processor configured to access the memory and further configured to execute the computer-executable instructions operable to:
receive event data from one or more data management systems;
based at least in part on the received event data, determine at least one emergency event exists;
output, via a display device, a scaled geospatial arrangement corresponding with a physical location, a grid, or a list; and
output, via the display device, at least one color corresponding to the at least one emergency event, wherein the at least one color is one of a set of pre-assigned colors.

2. The system of claim 1, wherein the data management systems comprise at least one of the following: a clinical system, an ADT system, an admission system, an environmental service system, an order and results system, a case management system, a transporter system, and a data system with event data associated with a patient care facility.

3. The system of claim 1, wherein the event data comprises at least one of the following: a real time event, data associated with a patient, and data associated with a patient care facility.

4. The system of claim 1, wherein the computer-executable instructions are further operable to:
output, via the display device, text corresponding to the at least one emergency event.

5. The system of claim 4, wherein the computer-executable instructions are further operable to:
overlay the at least one color and text on the scaled geospatial arrangement.

6. The system of claim 1, wherein the emergency event comprises at least one of the following: missing infant or child, bomb threat, suspicious object, missing adult, severe weather, hazardous material release, decontamination incident, fire, smoke, suspicious smell or odor, armed person or person with a weapon, hostage situation, violent situation, external disaster, internal disaster, utility failure, adult medical emergency, pediatric medical emergency, or neo-natal medical emergency.

7. The system of claim 1, wherein the computer-executable instructions are further operable to:
receive one or more user inputs correlating the at least one emergency event to the at least one color.

8. The system of claim 1, wherein the set of pre-assigned colors is based at least in part on user selection or a predefined priority.

9. A method, comprising:
receiving event data from one or more data management systems;
based at least in part on the received event data, determining at least one emergency event exists;
outputting, via a display device, a scaled geospatial arrangement corresponding with a physical location, a grid, or a list; and
outputting, via a display device, at least one color corresponding to the at least one emergency event, wherein the at least one color is one of a set of pre-assigned colors.

10. The method of claim 9, wherein the data management systems comprise at least one of the following: a clinical system, an ADT system, an admission system, an environmental service system, an order and results system, a case management system, a transporter system, and a data system with event data associated with a patient care facility.

11. The method of claim 9, wherein the event data comprises at least one of the following: a real time event, data associated with a patient, and data associated with a patient care facility.

12. The method of claim 9, further comprising:
outputting, via the display device, text corresponding to the at least one emergency event.

13. The method of claim 12, further comprising:
overlaying the at least one color and text on the scaled geospatial arrangement.

14. The method of claim 9, wherein the emergency event comprises at least one of the following: missing infant or child, bomb threat, suspicious object, missing adult, severe weather, hazardous material release, decontamination incident, fire, smoke, suspicious smell or odor, armed person or person with a weapon, hostage situation, violent situation, external disaster, internal disaster, utility failure, adult medical emergency, pediatric medical emergency, or neo-natal medical emergency

15. The method of claim 9, further comprising:
receiving one or more user inputs correlating the at least one emergency event to the at least one color.

16. The method of claim 9, wherein the set of pre-assigned colors is based at least in part on user selection or a predefined priority.

17. One or more computer-readable media storing computer-executable instructions that, when executed by at least one processor, configure the at least one processor to:
receive event data from one or more data management systems, wherein the data management systems comprise at least one of the following: a clinical system, an ADT system, an admission system, an environmental service system, an order and results system, a case management system, a transporter system, and a data system with event data associated with a patient care facility;
determine at least one emergency event exists;
output, via a display device, a scaled geospatial arrangement corresponding with a physical location, a grid, or a list;
output, via a display device, at least one color corresponding to the at least one emergency event, wherein the at least one color is one of a set of pre-assigned colors;
output, via the display device, text corresponding to the at least one emergency event; and
overlay the at least one color and text on at least one of a scaled geospatial arrangement corresponding with a physical location, a grid, or a list.

18. The computer readable media of claim 17, wherein the event data comprises at least one of the following: a real time event, data associated with a patient, and data associated with a patient care facility.

19. The computer readable media of claim 17, wherein the emergency event comprises at least one of the following: missing infant or child, bomb threat, suspicious object, missing adult, severe weather, hazardous material release, decontamination incident, fire, smoke, suspicious smell or odor, armed person or person with a weapon, hostage situation, violent situation, external disaster, internal disaster, utility failure, adult medical emergency, pediatric medical emergency, or neo-natal medical emergency

20. The computer readable media of claim 17, further configured to receive one or more user inputs correlating the at least one emergency event to the at least one color.
